(19) United States
(12) Patent Application Publication
(10) Pub. No.: US 2024/0289182 A1
(43) Pub. Date: Aug. 29, 2024

(54) APPARATUS AND METHOD

(71) Applicants: Garrett CLAY, Beaverton, OR (US); Jaemon FRANKO, Gig Harbor, WA (US); Heung-for CHENG, Hillsboro, OR (US)

(72) Inventors: Garrett CLAY, Beaverton, OR (US); Jaemon FRANKO, Gig Harbor, WA (US); Heung-for CHENG, Hillsboro, OR (US)

(21) Appl. No.: 18/657,825

(22) Filed: May 8, 2024

Related U.S. Application Data
(60) Provisional application No. 63/551,108, filed on Feb. 8, 2024.

(51) Int. Cl. G06F 9/50; G06F 11/30

(52) U.S. Cl. CPC G06F 9/5094; G06F 11/3058

(57) ABSTRACT

It is provided an apparatus comprising interface circuitry, machine-readable instructions, and processing circuitry to execute the machine-readable instructions. The machine-readable instructions comprise instructions to control each processor core of a plurality of processor cores of a first processing circuitry to execute a respective workload. The machine-readable instructions further comprise instructions to obtain temperature measurement data from each processor core of the plurality of processor cores. The temperature measurement data is acquired during the executing the respective workloads by the respective processor core of plurality of processor cores. The machine-readable instructions further comprise instructions to determine a physical layout of the first processing circuitry based on the obtained temperature measurement data from each processor core of the plurality of processor cores of the first processing circuitry.

### BACKGROUND

Processor manufacturers often keep the details of the spatial layout on a processor die confidential, particularly concerning how multiple processor cores may be arranged. For example, the physical configuration of cores and other circuit elements may significantly influence performance, power efficiency, and heat distribution.

### BRIEF DESCRIPTION OF THE FIGURES

Some examples of apparatuses and/or methods will be described in the following by way of example only, and with reference to the accompanying figures, in which

FIG. 1A illustrates a block diagram of an example of an apparatus;

FIG. 1B illustrates a block diagram of an example of an apparatus;

FIG. 2A illustrates a flowchart of an example of a method;

FIG. 2B illustrates a flowchart of an example of a method;

FIG. 3A illustrates a temperature distribution over the physical layout of the first processing circuitry with a first core being stressed;

FIG. 3B illustrates a temperature distribution over the physical layout of the first processing circuitry with a second core being stressed;

FIG. 4 shows a temperature curve over time of a stressed processor and a temperature curve over time of an idle processor core;

FIG. 5 illustrates a linear regression between the collected temperature data of a stressed core and an idle core;

FIG. 6 illustrates a cluster analysis performed on obtained regression coefficients of one core;

FIG. 7 illustrates an embodiment of standard configurations of cores belonging to different cluster or dies in a 1D, 2D or 3D layout; and

FIG. 8 illustrates three possible placements for any given core within a physical layout of the first processing circuitry.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

As described above processor manufacturers may not publish the physical layout of a processing circuitry comprising a plurality of processor cores on a die. In some examples a core identifier (ID) (for instance the Central Processing Unit Identifier (CPUID)) may not provide the operating system (OS) with physical layout information regarding processor cores (for example, core with ID ‘0’ and core with ID ‘1’ may not be adjacent to each other). However, knowledge about the physical core layout from the OS could be used for a variety of purposes.

The proposed concept may execute a power-intensive workload on a single (processor) core, while all other cores being idle. Then according to the proposed concept, a temperature of all (or some) cores may be recorded. Then it may be deduced which cores are near the core producing the (main) heat. By repeating this process for every core in the processing circuitry a core layout of the die may be inferred. For instance, machine learning techniques may be used in this regard.

Based on the inferred the physical layout of the processing circuitry (“core layout”), this may be used for a variety of uses. For example, the OS may choose to distribute workloads onto cores that are physically distant. By spreading the temperature more evenly across the die, a processor cooling system may require less energy (increased energy efficiency) and the cores may be less likely to hit thermal throttles (greater performance). Furthermore, a thermal degradation of the part will be reduced (better longevity). In yet another example, surrounding cores may be used to perform a software-only thermal shmoo plot (a thermal shmoo plot may be a graphical representation used to characterize and analyze the performance and stability of a processor under various temperature conditions).

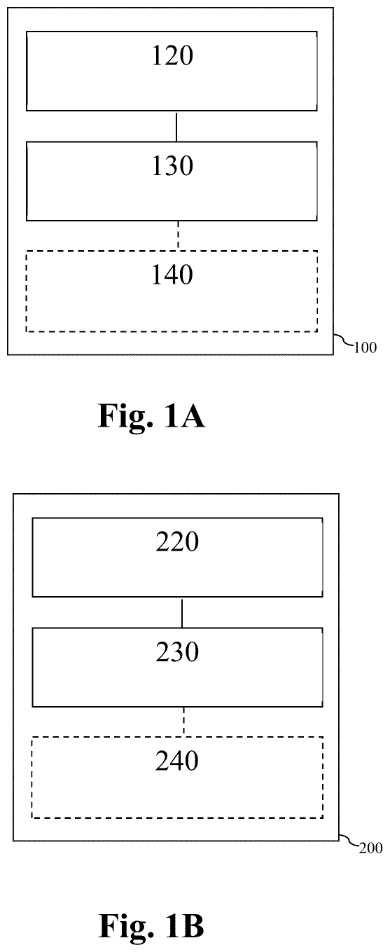

FIG. 1A illustrates a block diagram of an example of an apparatus 100 or device 100. The apparatus 100 comprises circuitry that is configured to provide the functionality of the apparatus 100. For example, the apparatus 100 of FIG. 1A comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1A comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to control each processor core of a plurality of processor cores of a first processing circuitry to execute a respective workload. Further, the processing circuitry 130 is configured to obtain temperature measurement data from each processor core of the plurality of processor cores. The temperature measurement data is acquired during the executing of the respective workloads by the respective processor core of the plurality of processor cores. For example, each of the processor cores of the first processing circuitry is controlled to sequentially execute a respective workload.

A workload executed by a processor core may consist of specific computational tasks and processes that the processor core is responsible for handling, such as running applications, performing calculations, or processing data. The executing of workload produces heat by the processor core due to the electrical energy used by the process core's electrical components (such as transistors) during operation. Therefore, the more intensive the workload executed by the stressed processor core, the greater the energy consumption and the more heat may be generated. For example, each of the respective workloads executed by the each of the plurality of processor cores may be identical. In another example, the respective workloads may be different for each of the plurality of processor cores.

In some examples, the temperature measurement data comprises one or more individual temperature measurements of one or more processor cores of the plurality of processor cores of the first processing circuitry, measured by one or more dedicated sensors assigned to one or more of the processor cores. For example, individual temperature measurements of a processor core may be expressed in Celsius, Fahrenheit, or Kelvin or the like. In some examples, the temperature measurement data may be acquired at predetermined time intervals. For example, an individual temperature measurement of a processor cores of the plurality of processor core may be measured a dedicated sensor every 5 ms or 20 ms or 100 ms or 200 ms the like.

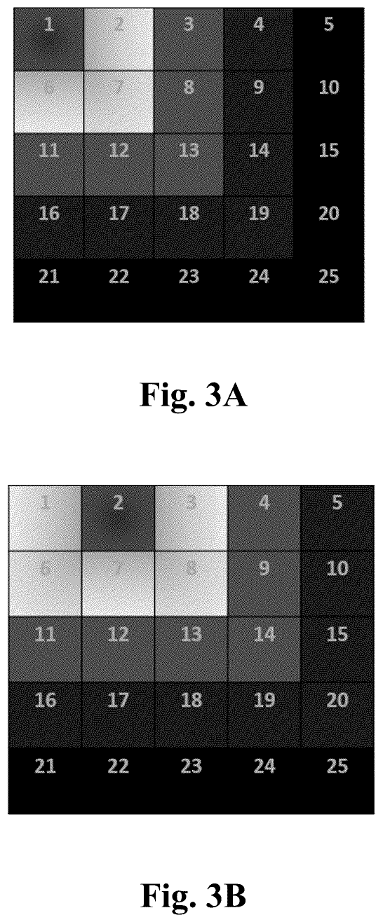

In some examples, the obtained temperature measurement data comprises, for each of the plurality of processor cores, a respective temperature measurement data set corresponding to a respective processor core. A temperature measurement data set which corresponds to a particular processor core may comprise temperature measurement data of the plurality of processor cores acquired while the particular processor core is executing the respective workload. In other words, the temperature measurement data may comprise as many temperature measurement data sets as there are processers, because there is one temperature measurement data set for each of the plurality of processors (see also FIGS. 3A and 3B). Each of the temperature measurement data sets may comprise a temperature measurement for each of the plurality of processor cores acquired while the particular processor core (to which this temperature measurement data set corresponds) is executing the respective workload.

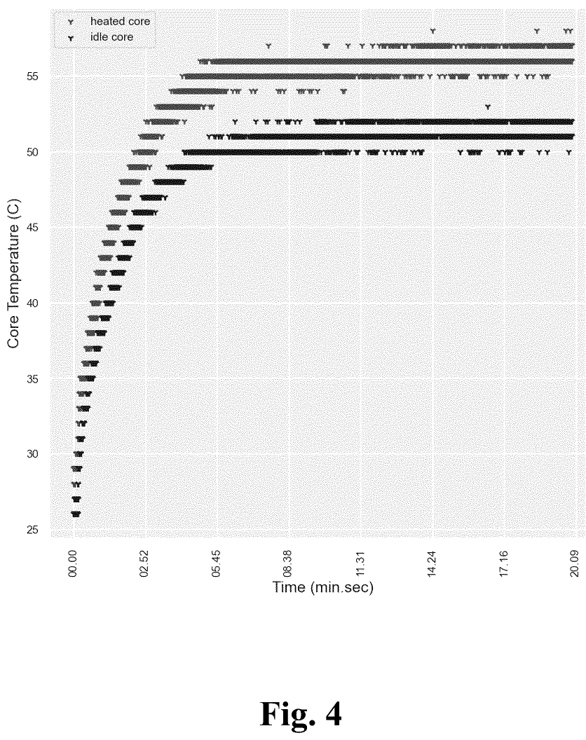

In some examples, the processing circuitry 130 may be configured to control each processor core of the plurality of processor cores to execute the respective workload for a predetermined time. For example, the predetermined time may be 15 seconds or 20 seconds or 30 seconds or 40 seconds or 1 minute or the like. For example, after the predetermined time period is over, the processing circuitry 130 stops the respective processor core from executing its respective workload and continues to control the next processor core to execute its respective workload until each processor core executed its respective workload. For example, the processing circuitry 130 may be configured to start controlling the first processor core of the plurality of processor cores to execute its respective workload for the predetermined time and then continues with the second processor core executing its respective workload for the predetermined time until the last processor core executed its respective workload for the predetermined time. For example, during each execution phase of a respective processor core, the individual temperature of all processor cores is measured and recorded (see also FIG. 4 below).

In some examples, the processing circuitry 130 is configured to control each processor core of the plurality of processor cores to execute the respective workload until a change in temperature of the obtained respective temperature measurement data of the workload executing processor core is below a predetermined threshold. For instance, the change in temperature is determined as the change in temperature of the processor core executing the workload over time. For example, if the change in temperature of the processor core executing the workload changes less than 0.5° or 1° or 1.5° or the like the executing of the workload by the respective processor core is stopped. For example, after the change in temperature falls below the predetermined threshold, the processing circuitry 130 stops the respective processor core from executing its respective workload and continues to control the next processor core to execute its respective workload until each processor core executed its respective workload. For example, during each execution phase of a respective processor core, the individual temperature of all processor cores is measured and recorded (see also FIG. 4 below).

Further, the processing circuitry 130 is configured to infer a physical layout of the first processing circuitry based on the obtained temperature measurement data from each processor core of the plurality of processor cores of the first processing circuitry. In some examples, the physical layout comprises a spatial positioning of the processor cores within the first processing circuitry. For example, the physical layout of the first processor circuitry comprises a main geometric configuration (line, square, cube etc.) and spatial coordinates that define the positions of processor cores of the first processing circuitry. For example, the physical layout may be defined in a one-dimensional (1D), two-dimensional (2D) or three-dimensional (3D) space.

In a 1D physical layout, the processor cores may be arranged on a single line, for example as straight line. In a 2D physical layout, the processor cores may be arranged on a single plane, for example in a square or rectangle, for example in rows and columns that form a grid pattern. In the 2D physical layout of processor cores, the processor cores may share edges, corners, or have no shared boundaries at all, depending on their placement within the layout. Sharing edges provides a longer contiguous boundary for cores, facilitating a greater area for heat transfer between adjacent processor cores. This means that a core can potentially receive more heat from a neighboring core the more edge they share. When cores share corners, they are connected at a single point, resulting in less direct interaction and minimal heat transfer compared to edge-sharing. If cores do not share any boundary, the heat transfer between them may be lower.

In a 3D physical layout, the processor cores may be arranged in cube or rectangular. For example, the processor cores may be arranged in stacked layers, wherein each layer may be arranged in rows and columns. In the 3D physical layout, the processor cores may share edges, corners, and surfaces, or have no shared boundaries. The sharing of surfaces between stacked cores allows for significant heat transfer than even more than in edge-sharing, due to the larger area of contact. Similarly, sharing edges and corners in a 3D space also facilitates heat transfer but to a lesser extent than surface-sharing. Cores that do not share any direct contact in a 3D arrangement are least affected by the heat generated from their neighbors, similar to the dynamics in a 2D configuration.

In some examples, the first processing circuitry is identical to the processing circuitry 130. In another examples, the first processing circuitry and the processing circuitry 130 are distinct processing circuitries. For example, the processing circuitry 130 may obtain data such as the temperature measurement data etc. via the interface circuitry 120 from the first processing circuitry.

For example, the inferred physical layout of the first processing circuitry may be used for variety of uses. In some examples, the processing circuitry 130 (or the first processing circuitry in case that they are distinct) may be configured to distribute a processing load among the plurality of processor cores of the first processor based on the inferred physical layout. For example, the processing circuitry 130 (or the first processing circuitry in case that they are distinct) may to distribute a workload onto the plurality of cores that are physically distant in order to obtain a more even temperature distribution among the first processing circuitry. By spreading the temperature more evenly across the first processing circuitry (i.e., the die), a cooling system may require less energy, which yields increased energy efficiency. Further, by spreading the temperature more evenly across the first processing circuitry the plurality of processor cores may be less likely to hit thermal throttles which yields a greater performance. Further, by spreading the temperature more evenly across the first processing circuitry a thermal degradation of the first processor circuitry may be reduced which yields a better longevity.

In some examples, the processing circuitry 130 is configured to determine numeric values for each processor core of the plurality of processor cores. For a particular processor core, the numeric values for said particular processor core may describe a respective relationship between a temperature pattern of the temperature measurement data of the particular processor core from the temperature measurement data set of said particular processor core and temperature patterns of the respective temperature measurement data of the other processor cores from the temperature measurement data set of said particular processor core. In other words, for each processor core there may be determined as numeric values as numeric values as there are processor cores. A temperature pattern of a particular processor core may be a temperature curve of that particular processor core. For example, it may be the temperature curve while an adjacent processor core is executing workload and radiating heat or the temperature curve while the particular processor core executing workload and thereby being stressed (i.e. being actively heated by executing the workload).

For example, the numeric values for a particular processor core may describe the relationship between the temperature curve of the particular processor core and temperature curve of all the other processor cores. For example, for a particular processor core, there may be one numeric value for describing the relationship between the temperature curve of the particular processor core and temperature curve of one of the processor cores. For example, if there are N processor cores, there may be N*N numeric values, or N*(N−1) numeric values. For example, the relationship between relationship between the temperature curve of the particular processor core and temperature curve of this processor core itself may be defined as 1 or as constant.

For example, the relationship between the temperature curve of a particular processor core and temperature curve of another processor core may be approximately described by a polynomial relationship (for example linear, or quadratic or cubic) or by an exponential or logarithmic relationship or the like. That is the temperature rise of a particular processor core may result in a linear, or quadratic or cubic or exponential or logarithmic temperature rise of the other processor core. In some examples, the respective relationship is a linear relationship.

In some examples, the processing circuitry 130 may be configured to perform, for each processor core of the plurality of processor cores, a regression analysis. For a particular processor core, the regression analysis may be performed between the temperature measurement data of the particular processor core from the temperature measurement data set of said particular processor core and the respective temperature measurement data of the other processor cores from the temperature measurement data set of said particular processor core.

For example, regression analysis may a technique used to examine the relationship between a dependent variable and one or more independent variables. For example, the regression analysis may involve determining one or more regression coefficients, which are numerical values that quantify the expected change in the dependent variable for a one-unit change in each independent variable, while holding other variables constant. For example, the regression analysis may be a polynomial regression, which fits a polynomial equation to data. For example, the regression analysis may be a linear regression, where the relationship is modeled as a straight line, which is a specific case of polynomial regression. In this case the regression coefficient may be referred to as linear regression coefficient. That is the linear regression coefficient tells how much the dependent variable is expected to increase (or decrease) with each one-unit increase in the independent variable. For example, the regression analysis may be a logistic regression, which may be used for binary outcomes. In other words, for a particular processor core (which may be executing the workload and thereby being stressed), the regression analysis may be performed between the temperature measurement data of that particular processor core (dependent variable) and the respective temperature measurement data of another processor core (independent variable) in order to determined how the temperature measurement of the other processor core behaves dependent on the temperature measurement of the particular stressed processor core. This may be done for each processor core while it is stressed (i.e., executing workload). For example, the regression analysis between a particular processor core and itself may yield a regression coefficient of 1.

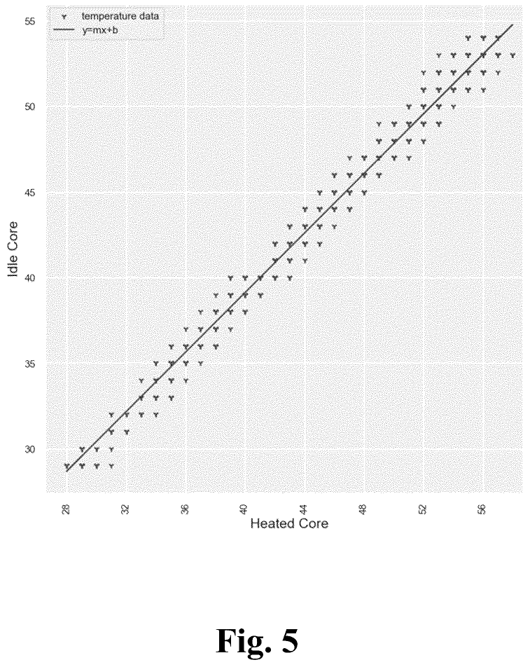

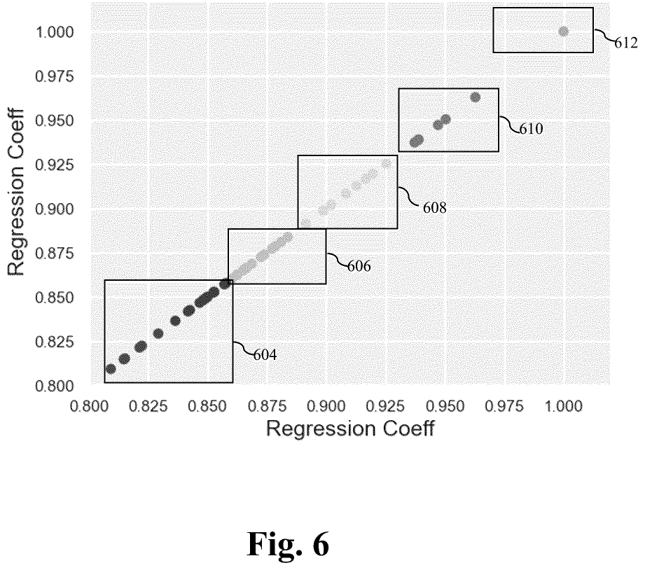

In some examples, the processing circuitry 130 may be configured to perform, for each processor core of the plurality of processor cores, a linear regression analysis, wherein for a particular processor core, the linear regression analysis is performed between the temperature measurement data of the particular processor core from the temperature measurement data set of said particular processor core and the respective temperature measurement data of the other processor cores from the temperature measurement data set of said particular processor core. Further, the processing circuitry 130 may be configured to determine, for each processor core of the plurality of processor cores, linear regression coefficients, wherein for a particular processor core, the linear regression coefficients for said particular processor describe a respective linear relationship between the temperature measurement data of said particular processor from the temperature measurement data set of said particular processor core and the respective temperature measurement data of the other processor cores from the temperature measurement data set of said particular processor core. For example, this may lead to a matrix like structure, where for each processor core (while it is stressed) a liner coefficient of each other processor core is determined (see also Table 1 below and FIGS. 5 and 6). The linear regression coefficient between a particular processor core and itself may be 1.

In some examples, the processing circuitry 130 may be configured to determine, for each processor core of the plurality of processor, a clustering of the plurality of processor cores into a number of clusters. For a particular processor core, the clustering may be based on the temperature measurement data set corresponding to said particular processor core. Clustering may be technique used to organize a set of objects into groups, or clusters, based on similarities in certain characteristics or attributes. For example, for a particular processor core a corresponding clustering of all the plurality of processor cores into a number of clusters is based in the regression coefficients that were determined for each processor core while the particular processor core was stressed. This clustering may be performed for each of the processor cores. That is there may be performed as many clusterings as there are processor cores. For example, the clustering of the processor cores into clusters may indicate—from the viewpoint of a particular stressed processor core—if another processor core is near, or far, or very far away from the particular stressed processor core. In other words, the clustering clusters the processor cores, from the viewpoint of a particular stressed processor core, into similar temperature response patterns.

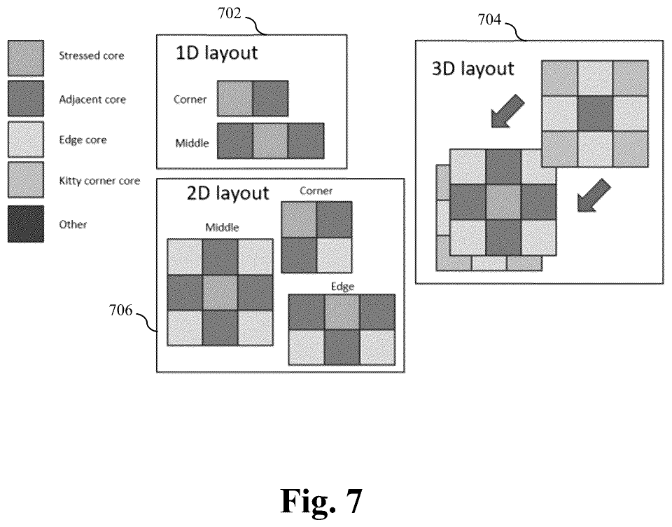

For example, for clustering well known clustering algorithms such as o k-means, K-medoids, hierarchical clustering, Density-Based Spatial Clustering of Applications with Noise, spectral clustering, mean shift clustering, Gaussian Mixture Models (GMM), and agglomerative clustering or the like. For example, k-means algorithm performs clustering of the plurality of processor cores into a predetermined number of k clusters. The k clusters may non-overlapping clusters (each processor is only in one cluster) based on the distance from the mean value of the points in a cluster, which minimizes the within-cluster sum of squares (variance). For example, for a particular processor core and its respective regression coefficients, the k-means algorithm may iteratively assign each processor core to a cluster based on the regression coefficient. For example, the total distance between the processor cores (i.e., their regression coefficient) and their respective cluster center (mean) is minimized, ensuring that cores with similar temperatures are grouped together (see also FIG. 7). The number of clusters may be fixed, i.e., k=4 1D/2D physical layout or k=5 for 3D physical layouts. For example, cluster A may comprise the stressed processor core (also referred to as stressed core). For example, a cluster B may be the cluster of processor cores nearest to cluster A. There may be however no predetermined range for what coefficients will fall in cluster B. In some examples, there may be a spatial limit to how many processor cores may be in a cluster. For example, cluster B represents the processor cores sharing a surface with the stressed core (cluster A). If the stressed core is considered to be a cube, in a 3D physical layout of processor cores, there are only 6 surfaces on the cube which corresponds to a maximum of 6 cores in cluster B. In a 1D/2D physical layout the maximum number of cores in cluster B may be 4.

In yet another example, for a particular processor core, each cluster of the plurality of clusters may comprise processor cores corresponding to numeric values of the numeric values of said particular processor core within a range. For example, the numeric values may be the regression coefficients. For example, each cluster may be defined by a predetermined range and each regression coefficient falling inside this predetermined range may be inside its corresponding cluster.

In some examples, the processing circuitry 130 may be configured to determine the physical layout of the first processing circuitry based on the determined numeric values of each processor core of the plurality of processor cores. The numeric values indicated how the temperature curve of a processor core is behaving while a particular processor core is stressed. Because a temperature rise of a processor core which is farer away from a stressed core is heated slower than a processor core which is nearer to the stressed core, this may be indicated by the numeric value. This may yield a relative positioning of each processor to each other processor. Based on this information the physical layout may be inferred.

In some examples, the processing circuitry 130 may be configured to determine the physical layout of the first processing circuitry based on the determined clustering of each processor core of the plurality of processor cores. As described above, the numeric values indicated how the temperature curve of a processor core is behaving while a particular processor core is stressed. This may be further lead to a clustering of the processor cores into clusters, which indicate—from the viewpoint of a particular stressed processor core—if another core is near or far or very far away from the particular stressed processor core. Based on these clusters which indicate the relative positioning of each processor to each other processor and which may be obtained for each processor core while it is stressed, the physical layout may be inferred.

In some examples, an artificial neural network (ANN) may be trained to infer the physical layout. For example, the ANN may during training receive as input the clustering for each processor core the processing circuitry and a physical layout of the corresponding processing circuitry to perform supervised learning. After training the ANN it may be used it infer the physical layout of the first processing circuitry based on the clustering of each processor core.

In some examples, the processing circuitry 130 may be configured to determine the physical layout of the first processing circuitry based on correlating the determined clustering of each processor core of the plurality of processor cores. In some examples, only some of the determined clusterings of some processor cores of the plurality of processor cores may be correlated. For example, the correlation may refer to the statistical technique used to infer the degree of association between the clustering results obtained from each stressed processor core. The correlation between the clustering results of each stressed processor core involves comparing the clustering outputs to see which processor cores consistently appear in similar clusters across different sets of stressed processor cores. A high correlation in clustering patterns indicates that certain processor cores are likely in close physical proximity. By analyzing these correlations, the spatial arrangement of the processor cores within the first processing circuitry is inferred—processor cores that frequently end up in the same clusters are likely positioned near each other. For example, correlation may utilize specific methods such as multidimensional scaling (MDS) or principal component analysis (PCA) to visualize and quantify the similarity between the clustering results for each processor core. By applying these techniques, the data derived from k-means clustering of the regression coefficients can be transformed into a spatial representation where the distance between points (representing cores) on a plot corresponds to their degree of similarity in clustering outcomes. This visual and quantitative analysis may show patterns, such as clusters of cores that consistently group together across multiple tests, suggesting their close proximity or similar thermal response within the processor layout.

In some examples, the processing circuitry 130 may be configured to determine, for each processor core of the plurality of processor cores, a positional classification within the physical layout of the first processor circuitry, based on at least one of the determined clusterings of the plurality of processor cores. Further, the processing circuitry 130 may be configured to
determine the physical layout of the first processing circuitry based on determined positional classification and the clustering of each processor core of the plurality of processor cores. The positional classification may be a define the position of a processor core relative to the main geometry of the physical layout of the first processing circuitry. The main geometry of the physical layout of the first processing circuitry may define the physical layout as a line or a square or rectangle or cube or the like. The positional classification may therefore define a processor core as being near for far to the center or the outer part of the main geometry of the physical layout of the first processing circuitry. For example, a positional classification may be a corner position, an edge position, or a central position of a processor core within the physical layout. In case of the physical layout being a 3D layout, the positional classification may be a bottom layer position, or mid-layer position or upper layer position or the like. In a first step of a correlation analysis each processor core may be classified into a positional classification within the physical layout and then in a second step of the correlation analysis based on these positional classifications a final physical layout of the first processing circuitry may be determined.

In some examples, the processing circuitry 130 may be configured to infer the physical layout of the first processing circuitry comprising the plurality of processor cores as follows: 1. The processing circuitry 130 selects a stressed core X (e.g., the core running power-intensive workload), and in 3D layout all of the cores in 2^{nd}, 3^{rd}, 4^{th} clusters in a way that maximizes thermal affinity and does not violate spatial rules (e.g. no more than 6× adjacent cores, 12× edge cores, etc.). 2. The processing circuitry 130 picks a core from those surrounding core X, starting with cores in 2^{nd} cluster, then 3^{rd}, and then 4^{th}, and repeat step 1. for that core to fill out the nearby cores. This process stops when all cores in 2^{nd}, 3^{rd}, 4^{th} clusters have been mapped. 3. If there are cores that are not mapped in steps 1 and 2, processing circuitry 130 repeat steps 1 and 2 until all cores in the system have been mapped (i.e. may result in many independent islands of mapped cores due to multiple tiles, dies or otherwise thermally isolated cores). 4. If there are multiple islands of mapped cores, processing circuitry 130 orients them according to knowledge obtained from the cores that fall into 5^{th} cluster in phase 3.

Further details and aspects are mentioned in connection with the examples described below. The example shown in FIG. 1A may include one or more optional additional features corresponding to one or more aspects mentioned in connection with the proposed concept or one or more examples described below (e.g., FIGS. 1B-8).

FIG. 1B illustrates a block diagram of an example of an apparatus 200 or device 200. The apparatus 200 comprises circuitry that is configured to provide the functionality of the apparatus 200. For example, the apparatus 200 of FIG. 1B comprises interface circuitry 220, processing circuitry 230 and (optional) storage circuitry 240. For example, the processing circuitry 230 may be coupled with the interface circuitry 220 and optionally with the storage circuitry 240. The circuitry of apparatus 200 may be similar to circuitry of apparatus 100 of FIG. 1A.

For example, the processing circuitry 230 may be configured to provide the functionality of the apparatus 200, in conjunction with the interface circuitry 220. For example, the interface circuitry 220 is configured to exchange information, e.g., with other components inside or outside the apparatus 200 and the storage circuitry 240. Likewise, the device 200 may comprise means that is/are configured to provide the functionality of the device 200.

The processing circuitry 230 is configured to control each of a component of computer architecture block to process a respective workload. The processing circuitry 230 is further configured to obtain temperature measurement data from each component of the computer architecture block. The temperature measurement data is acquired during the processing of the respective workloads by the respective component. The processing circuitry 230 is further configured to infer a physical layout of the computer architecture block based on the obtained temperature measurement data from each component of the computer architecture block.

The computer architecture block may refer to a distinct functional unit within a computer system, that may comprise one or more components, designed to perform specific tasks integral to the overall operation and performance of the system. For example, the computer system may be connected to the processing circuitry 230 via the interface circuitry 220 (in some examples the computer system may be the apparatus 200). The computer architecture block may be a memory, which stores and retrieves data and instructions for processor use. In some examples, the computer architecture block may an uncore, which may encompass various non-core elements such as memory controllers, interconnects, and peripheral controllers that support the processor cores by managing data flow and connectivity. In some examples, the computer architecture block may an AI compute unit, which may be a specialized hardware dedicated to accelerating artificial intelligence computations.

Similar as described with above with FIG. 1A with regards to the inferring of the physical layout of the first processing circuitry the of physical layout of the of the computer architecture block may be inferred.

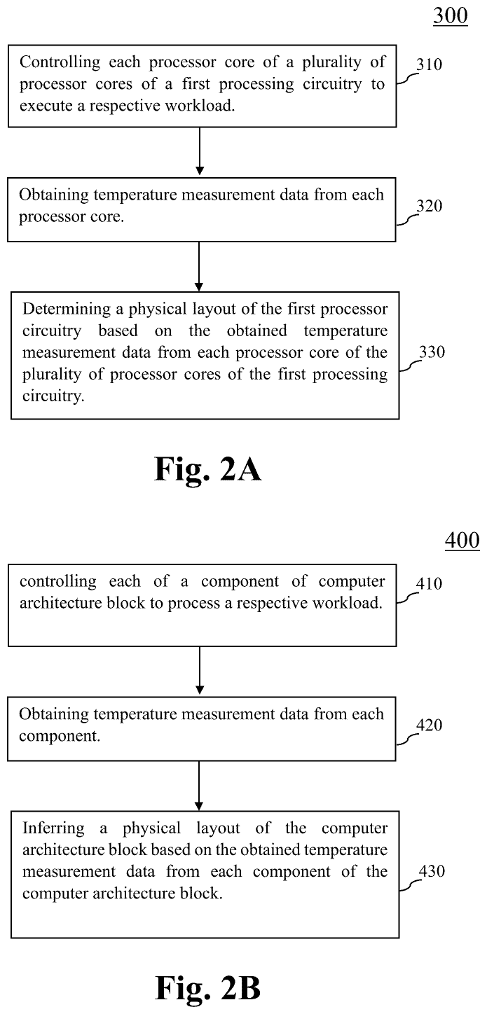

Further details and aspects are mentioned in connection with the examples described above or below. The example shown in FIG. 1B may include one or more optional additional features corresponding to one or more aspects mentioned in connection with the proposed concept or one or more examples described above (e.g., FIG. 1A) or below (e.g., FIGS. 2A-8).

FIG. 2A illustrates a flowchart of an example of a method 300. The method 300 may, for instance, be performed by an apparatus as described herein, such as apparatus 100. The method 300 comprises controlling 310 each processor core of a plurality of processor cores of a first processing circuitry to execute a respective workload. The method 300 further comprises obtaining 320 temperature measurement data from each processor core of the plurality of processor cores, wherein the temperature measurement data is acquired during the executing the respective workloads by the respective processor core of plurality of processor cores. The method 300 further comprises inferring 330 a physical layout of the first processing circuitry based on the obtained temperature measurement data from each processor core of the plurality of processor cores of the first processing circuitry.

More details and aspects of the method 300 are explained in connection with the proposed technique or one or more examples described above, e.g., with reference to FIG. 1A or below with regards to FIGS. 2B to 8. The method 300 may comprise one or more additional optional features corresponding to one or more aspects of the proposed technique, or one or more examples described above or below.

FIG. 2B illustrates a flowchart of an example of a method 400. The method 400 may, for instance, be performed by an apparatus as described herein, such as apparatus 200. The method 400 comprises controlling 410 each of a component of computer architecture block to process a respective workload. The method 400 further comprises obtaining 420 temperature measurement data from each component of the computer architecture block. The temperature measurement data is acquired during the processing of the respective workloads by the respective component. The method 400 further comprises inferring 430 a physical layout of the computer architecture block based on the obtained temperature measurement data from each component of the computer architecture block.

More details and aspects of the method 400 are explained in connection with the proposed technique or one or more examples described above, e.g., with reference to FIGS. 1A-2A or below with regards to FIGS. 3 to 8. The method 400 may comprise one or more additional optional features corresponding to one or more aspects of the proposed technique, or one or more examples described above or below.

### Examples

In one embodiment of the present disclosure, the concept of inferring a physical layout of a processing circuitry comprising a plurality of processor cores may comprise (one or some or all of) the following four phases: Phase 1: Collect temperature data (of the plurality of cores) by heating one core at a time using a power-intensive workload. When a particular core is running this power-intensive workload, all other cores may be idle. Phase 2: Use the collected temperature data and perform a linear regression between the stressed core and all other cores. Phase 3: Perform a cluster analysis on the regression data to determine the nearby cores for each stressed core. Phase 4: Correlate the nearby cores of every stressed core to determine the physical layout of the processing circuitry on the die. These four phases are described in more detail below.

### Phase 1: Temperature Data Collection:

In a first phase of disclosed technique of inferring a physical layout of a processing circuitry comprising a plurality of processor cores may comprise collecting thermal telemetry data from each processor in the system under test. Therefore, for instance, publicly available performance registers may be used to monitor the core temperatures. For example, the following procedure may be carried out in this regard: 1. Collect all individual core temperatures (of all processor cores of a processing circuitry) in a predetermined time interval, for instance every 200 milliseconds or the like. 2. Bind a power-intensive workload to one core. This may result in the core being heated over time. 3. Stop collecting core temperatures. 4. Repeat steps 1, 2 and 3 for every core in the processing circuitry (the system)

FIG. 3A illustrates a temperature distribution over the physical layout of the first processing circuitry with a first core being stressed. FIG. 3B illustrates a temperature distribution over the physical layout of the first processing circuitry with a second core being stressed. The dark red indicated the highest temperature. From light red to purple, dark blue to black, lowering temperature is indicated.

FIG. 4 shows a temperature curve over time of a stressed processor and a temperature curve over time of an idle processor core. The stressed and the idle processor core are both in the same processing circuitry. The rate at which the two temperature curves change and the temperature differences in the final temperatures of the two curves may be deduced from the curves and used as key indicators used to determine the proximity of the cores within the physical layout of the processing circuitry.

### Phase 2: Linear Regression on Collected Temperature Data:

In a second phase of disclosed technique of inferring a physical layout of a processing circuitry comprising a plurality of processor cores may comprise performing a linear regression on the collected temperature data of phase 1. For example, the following procedure may be carried out in this regard: 1. Run a linear regression between the stressed core and one other core of the processing circuitry and obtain a coefficient representing the temperature relationship between the two cores. 2. Repeat step 1 for every core on the system and obtain N−1 coefficients, where N is the number of processor cores in the processing circuitry (i.e., the system). 3. Repeat steps 1 and 2 for N datasets (each dataset being collected in phase 1 and corresponding to a different core being stressed).

FIG. 5 illustrates a linear regression between the collected temperature data of a stressed core and an idle core (see FIG. 4). In this regard, the graph in FIG. 5 illustrates the temperature of an idle core as a function of the temperature of the stressed core. The graph may be described with the linear equation y=mx+b, with y being the temperature of the idle core, x being the temperature of the stressed core, b being the y-intercept and m being the searched rate (coefficient) representing the degrees Celsius change in temperature of the idle core for every degree Celsius change of the stressed core. Therefore, the greater (approaching m=1) the coefficient m between an idle core and the stressed core is, the closer the two cores are. Inversely, the lower the coefficient (approaching m=0) between an idle core and the stressed core, the further the two cores are.

After deducing the N−1 regression coefficients for each of the N processor cores an ordered list of coefficients (matrix) for each stressed core may be created, as exemplified in Table 1:

TABLE 1

| Stressed Core 4 | | Stressed Core 6 | | Stressed Core 5 | | Stressed Core N | |
|---|---|---|---|---|---|---|---|
| | Coeffi- | | Coeffi- | | Coeffi- | | Coeffi- |
| Core | cient | Core | cient | Core | cient | Core | cient |
| 6 | 0.495588 | 4 | 0.57112 | 13 | 0.56442 | 5 | 0.59862 |
| 0 | 0.49430 | 5 | 0.56694 | 12 | 0.53890 | 12 | 0.59467 |
| 5 | 0.47365 | 12 | 0.56202 | 14 | 0.52610 | 33 | 0.59237 |
| . . . | | . . . | | . . . | | . . . | |
| N-1 | 0.38435 | N-1 | 0.46838 | N-1 | 0.44044 | N-1 | 0.52166 |

### Phase 3: Cluster Analysis Based on Regression Data:

A third phase of the disclosed technique of inferring a physical layout of a processing circuitry comprising a plurality of processor cores may comprise performing a cluster analysis on the table output of phase 2. This may be done using rule-based algorithms or machine learning algorithms known to the skilled person, such as a K-means algorithm. For instance, top 4-5 clusters may be identified as shown on FIG. 6.

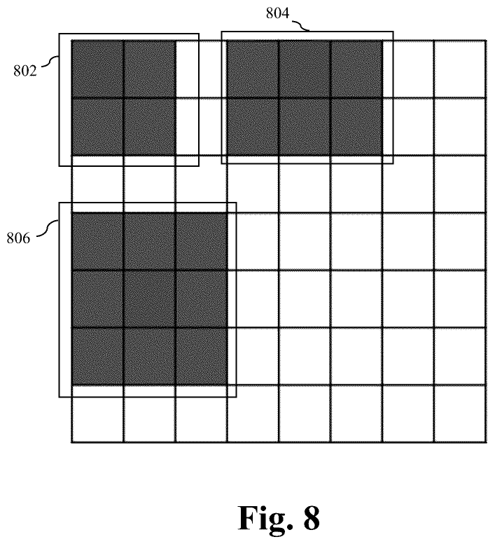

FIG. 6 illustrates a cluster analysis performed on obtained regression coefficients of one core. The cluster analysis may be performed by a K-means algorithm (for example K=4 or 5), based on the regression coefficients of one core obtained in phase 2. This clustering may be performed for each of the N−1 regression coefficients of the N cores, as obtained in phase 2. The identified clusters may have the following definitions: Cluster 1 may be the processing core running a power-intensive workload illustrated as the orange dots in box 612. Cluster 2 may be the closest cores to the processing core running a power-intensive workload, i.e., adjacent cores which are sharing a surface (with the processing core running a power-intensive workload) illustrated as the blue dots in box 610. Cluster 3 may be the second closest processing cores, i.e., edge cores which are sharing an edge (with the processing core running a power-intensive workload), illustrated as the green dots in box 608. Cluster 4 may be [this may be for stacked/3D layouts only] third closest cores, i.e., kitty corner cores which are sharing a cube corner (with the processing core running a power-intensive workload), illustrated as the teal dots in box 606 (see also FIG. 7). Cluster 5 may be all the other cores which are likely separated by one or more cores from the stressed core illustrated as the purple and red dots in box 604. This is also described with regards to FIGS. 7 and 8.

### Phase 4: Correlate Nearby Cores of Every Stressed Core to Determine Physical Layout:

A fourth phase of the disclosed technique of inferring a physical layout of a processing circuitry comprising a plurality of processor cores may comprise correlating nearby cores of every stressed core to determine physical layout. This may be based on the clustering results for each stressed core obtained in phase 3. Thereby, a possible physical layout (die layout) in 1D, 2D or 3D may be created programmatically. For instance, the process to map the processing cores according to their clustering/coefficient may be as follows:
1. Select a stressed core X (core running power-intensive workload), and in 3D space layout all of the cores in 2^{nd}, 3^{rd}, 4^{th} clusters in a way that maximizes thermal affinity and does not violate spatial rules (e.g. no more than 6× adjacent cores, 12× edge cores, etc.).
2. Pick a core from those surrounding core X, starting with cores in 2nd cluster, then 3^{rd}, and then 4^{th}, and repeat step 1. for that core to fill out the nearby cores. This process stops when all cores in 2nd, 3^{rd}, 4^{th} clusters have been mapped.
3. If there are cores that are not mapped in steps 1 and 2, repeat steps 1 and 2 until all cores in the system have been mapped (i.e. may result in many independent islands of mapped cores due to multiple tiles, dies or otherwise thermally isolated cores).
4. If there are multiple islands of mapped cores, orient them according to knowledge obtained from the cores that fall into 5th cluster in phase 3.

FIG. 7 illustrates an embodiment of standard configurations of cores belonging to different cluster or dies in a 1D, 2D or 3D layout. In box 702 a 1D layout of processing cores is illustrated, that is cores may be arranged in a row. In this regard cores may be clustered into corner cores or middle cores based on the results of phase 3. In box 704 a 2D layout of processing cores is illustrated, that is cores may be arranged in a plane. In this regard cores may be clustered into corner cores or middle cores and edge cores based on the results of phase 3 (see also FIG. 8). In box 706 a 3D layout of processing cores is illustrated, that is cores may be arranged in a cube. In this regard cores may be clustered into corner cores or middle cores and edge cores and kitty corner cores (see cluster 4 in phase 3 for instance) based on the results of phase 3.

If the die layout is a 2D layout the correlation process, may be taken into consideration that there may be three possible placements for any given core within the physical 2D layout as shown in FIG. 8. FIG. 8 illustrates three possible placements for any given core within a physical layout of the first processing circuitry. A core may be placed at a corner of a physical layout of a processing circuitry as shown in the box 802. A core may be placed at an edge but not at a corner of the physical layout of the processing circuitry as shown in the box 804. A core may be placed in the middle (and neither at a corner or an edge) of the physical layout of the processing circuitry as shown in the box 806.

Further details and aspects are mentioned in connection with the examples described above or below. The examples shown in FIGS. 3A-8 may include one or more optional additional features corresponding to one or more aspects mentioned in connection with the proposed concept or one or more examples described above (e.g., FIGS. 1A-2B).

In the following, some examples of the proposed concept are presented:

An example (e.g., example 1) relates to an apparatus comprising interface circuitry, machine-readable instructions and processing circuitry to execute the machine-readable instructions to control each processor core of a plurality of processor cores of a first processing circuitry to execute a respective workload, obtain temperature measurement data from each processor core of the plurality of processor cores, wherein the temperature measurement data is acquired during the executing of the respective workloads by the respective processor core of plurality of processor cores, and infer a physical layout of the first processing circuitry based on the obtained temperature measurement data from each processor core of the plurality of processor cores of the first processing circuitry.

Another example (e.g., example 2) relates to a previous example (e.g., example 1) or to any other example, further comprising that the processing circuitry is to execute the machine-readable instructions to distribute a processing load among the plurality of processor cores of the first processor based on the inferred physical layout.

Another example (e.g., example 3) relates to a previous example (e.g., one of the examples 1 or 2) or to any other example, further comprising that the obtained temperature measurement data comprises, for each of the plurality of processor cores, a respective temperature measurement data set corresponding to a respective processor core, wherein a temperature measurement data set corresponding to a particular processor core comprises temperature measurement data of the plurality of processor cores acquired while the particular processor core is executing the respective workload.

Another example (e.g., example 4) relates to a previous example (e.g., example 3) or to any other example, further comprising that the processing circuitry is to execute the machine-readable instructions to determine numeric values for each processor core of the plurality of processor cores, wherein for a particular processor core, the numeric values for said particular processor core describe a respective relationship between a temperature pattern of the temperature measurement data of the particular processor core from the temperature measurement data set of said particular processor core and temperature patterns of the respective temperature measurement data of the other processor cores from the temperature measurement data set of said particular processor core.

Another example (e.g., example 5) relates to a previous example (e.g., example 4) or to any other example, further comprising that the respective relationship is a linear relationship.

Another example (e.g., example 6) relates to a previous example (e.g., one of the examples 3 to 5) or to any other example, further comprising that the processing circuitry is to execute the machine-readable instructions to perform, for each processor core of the plurality of processor cores, a regression analysis, wherein for a particular processor core, the regression analysis is performed between the temperature measurement data of the particular processor core from the temperature measurement data set of said particular processor core and the respective temperature measurement data of the other processor cores from the temperature measurement data set of said particular processor core.

Another example (e.g., example 7) relates to a previous example (e.g., one of the examples 3 to 6) or to any other example, further comprising that the processing circuitry is to execute the machine-readable instructions to perform, for each processor core of the plurality of processor cores, a linear regression analysis, wherein for a particular processor core, the linear regression analysis is performed between the temperature measurement data of the particular processor core from the temperature measurement data set of said particular processor core and the respective temperature measurement data of the other processor cores from the temperature measurement data set of said particular processor core, and determine, for each processor core of the plurality of processor cores, linear regression coefficients, wherein for a particular processor core, the linear regression coefficients for said particular processor describe a respective linear relationship between the temperature measurement data of said particular processor from the temperature measurement data set of said particular processor core and the respective temperature measurement data of the other processor cores from the temperature measurement data set of said particular processor core.

Another example (e.g., example 8) relates to a previous example (e.g., one of the examples 3 to 7) or to any other example, further comprising that the processing circuitry is to execute the machine-readable instructions to determine, for each processor core of the plurality of processor, a clustering of the plurality of processor cores into a number of clusters, wherein for a particular processor core, the clustering is based on the temperature measurement data set corresponding to said particular processor core.

Another example (e.g., example 9) relates to a previous example (e.g., one of the examples 4 to 8) or to any other example, further comprising that the processing circuitry is to execute the machine-readable instructions to determine, for each processor core of the plurality of processor, a clustering of the plurality of processor cores into a number of clusters, wherein for a particular processor core, the clustering is based on the determined numeric values for said particular processor core of the plurality of processor cores.

Another example (e.g., example 10) relates to a previous example (e.g., example 9) or to any other example, further comprising that for a particular processor core, each cluster of the plurality of clusters comprises processor cores corresponding to numeric values of the numeric values of said particular processor core within a range.

Another example (e.g., example 11) relates to a previous example (e.g., one of the examples 4 to 10) or to any other example, further comprising that the processing circuitry is to execute the machine-readable instructions to determine the physical layout of the first processing circuitry based on the determined numeric values of each processor core of the plurality of processor cores.

Another example (e.g., example 12) relates to a previous example (e.g., one of the examples 8 to 11) or to any other example, further comprising that the processing circuitry is to execute the machine-readable instructions to determine the physical layout of the first processing circuitry based on the determined clustering of each processor core of the plurality of processor cores.

Another example (e.g., example 13) relates to a previous example (e.g., example 12) or to any other example, further comprising that the processing circuitry is to execute the machine-readable instructions to determine the physical layout of the first processing circuitry based on correlating the determined clustering of each processor core of the plurality of processor cores.

Another example (e.g., example 14) relates to a previous example (e.g., one of the examples 8 to 13) or to any other example, further comprising that the processing circuitry is to execute the machine-readable instructions to determine, for each processor core of the plurality of processor cores, a positional classification within the physical layout of the first processor circuitry, based on at least one of the determined clusterings of the plurality of processor cores, and determine the physical layout of the first processing circuitry based on determined positional classification and the clustering of each processor core of the plurality of processor cores.

Another example (e.g., example 15) relates to a previous example (e.g., example 14) or to any other example, further comprising that the positional classification within the physical layout of the first processor circuitry comprises a corner position, an edge position, or a central position of the physical layout of the first processor circuitry.

Another example (e.g., example 16) relates to a previous example (e.g., one of the examples 1 to 15) or to any other example, further comprising that the processing circuitry is to execute the machine-readable instructions to control each processor core of the plurality of processor cores to execute the respective workload for a predetermined time.

Another example (e.g., example 17) relates to a previous example (e.g., one of the examples 1 to 16) or to any other example, further comprising that the processing circuitry is to execute the machine-readable instructions to control each processor core of the plurality of processor cores to execute the respective workload until a change in temperature of the obtained respective temperature measurement data of the workload executing processor core is below a predetermined threshold.

Another example (e.g., example 18) relates to a previous example (e.g., one of the examples 1 to 17) or to any other example, further comprising that the temperature measurement data being acquired at predetermined time intervals.

Another example (e.g., example 19) relates to a previous example (e.g., one of the examples 1 to 18) or to any other example, further comprising that the physical layout comprises a spatial positioning of the processor cores within the first processing circuitry.

An example (e.g., example 20) relates to an apparatus comprising interface circuitry, machine-readable instructions and processing circuitry to execute the machine-readable instructions to control each of a component of computer architecture block to process a respective workload, obtain temperature measurement data from each component of the computer architecture block, wherein the temperature measurement data is acquired during the processing of the respective workloads by the respective component, and infer a physical layout of the computer architecture block based on the obtained temperature measurement data from each component of the computer architecture block.

Another example (e.g., example 21) relates to a previous example (e.g., example 20) or to any other example, further comprising that the computer architecture block is at least one of a memory, an uncore, an AI compute unit.

An example (e.g., example 22) relates to a method comprising controlling each processor core of a plurality of processor cores of a first processing circuitry to execute a respective workload, obtaining temperature measurement data from each processor core of the plurality of processor cores, wherein the temperature measurement data is acquired during the executing the respective workloads by the respective processor core of plurality of processor cores, and inferring a physical layout of the first processing circuitry based on the obtained temperature measurement data from each processor core of the plurality of processor cores of the first processing circuitry.

Another example (e.g., example 23) relates to a previous example (e.g., example 22) or to any other example, further comprising distributing a processing load among the plurality of processor cores of the first processor based on the inferred physical layout.

Another example (e.g., example 24) relates to a previous example (e.g., one of the examples 22 or 23) or to any other example, further comprising that the obtained temperature measurement data comprises, for each of the plurality of processor cores, a respective temperature measurement data set corresponding to a respective processor core, wherein a temperature measurement data set corresponding to a particular processor core comprises temperature measurement data of the plurality of processor cores acquired while the particular processor core is executing the respective workload.

Another example (e.g., example 25) relates to a previous example (e.g., example 24) or to any other example, further comprising determining numeric values for each processor core of the plurality of processor cores, wherein for a particular processor core, the numeric values for said particular processor core describe a respective relationship between a temperature pattern of the temperature measurement data of the particular processor core from the temperature measurement data set of said particular processor core and temperature patterns of the respective temperature measurement data of the other processor cores from the temperature measurement data set of said particular processor core.

Another example (e.g., example 26) relates to a previous example (e.g., example 25) or to any other example, further comprising that the respective relationship is a linear relationship.

Another example (e.g., example 27) relates to a previous example (e.g., one of the examples 24 to 26) or to any other example, further comprising performing, for each processor core of the plurality of processor cores, a regression analysis, wherein for a particular processor core, the regression analysis is performed between the temperature measurement data of the particular processor core from the temperature measurement data set of said particular processor core and the respective temperature measurement data of the other processor cores from the temperature measurement data set of said particular processor core.

Another example (e.g., example 28) relates to a previous example (e.g., one of the examples 24 to 27) or to any other example, further comprising performing, for each processor core of the plurality of processor cores, a linear regression analysis, wherein for a particular processor core, the linear regression analysis is performed between the temperature measurement data of the particular processor core from the temperature measurement data set of said particular processor core and the respective temperature measurement data of the other processor cores from the temperature measurement data set of said particular processor core, and determining, for each processor core of the plurality of processor cores, linear regression coefficients, wherein for a particular processor core, the linear regression coefficients for said particular processor describe a respective linear relationship between the temperature measurement data of said particular processor from the temperature measurement data set of said particular processor core and the respective temperature measurement data of the other processor cores from the temperature measurement data set of said particular processor core.

Another example (e.g., example 29) relates to a previous example (e.g., one of the examples 24 to 28) or to any other example, further comprising determining, for each processor core of the plurality of processor, a clustering of the plurality of processor cores into a number of clusters, wherein for a particular processor core, the clustering is based on the temperature measurement data set corresponding to said particular processor core.

Another example (e.g., example 30) relates to a previous example (e.g., one of the examples 25 to 29) or to any other example, further comprising determining, for each processor core of the plurality of processor, a clustering of the plurality of processor cores into a number of clusters, wherein for a particular processor core, the clustering is based on the determined numeric values for said particular processor core of the plurality of processor cores.

Another example (e.g., example 31) relates to a previous example (e.g., example 30) or to any other example, further comprising that for a particular processor core, each cluster of the plurality of clusters comprises processor cores corresponding to numeric values of the numeric values of said particular processor core within a range.

Another example (e.g., example 32) relates to a previous example (e.g., one of the examples 25 to 31) or to any other example, further comprising determining the physical layout of the first processing circuitry based on the determined numeric values of each processor core of the plurality of processor cores.

Another example (e.g., example 33) relates to a previous example (e.g., one of the examples 29 to 32) or to any other example, further comprising determining the physical layout of the first processing circuitry based on the determined clustering of each processor core of the plurality of processor cores.

Another example (e.g., example 34) relates to a previous example (e.g., example 33) or to any other example, further comprising determining the physical layout of the first processing circuitry based on correlating the determined clustering of each processor core of the plurality of processor cores.

Another example (e.g., example 35) relates to a previous example (e.g., one of the examples 29 to 34) or to any other example, further comprising determining, for each processor core of the plurality of processor cores, a positional classification within the physical layout of the first processor circuitry, based on at least one of the determined clusterings of the plurality of processor cores, and determining the physical layout of the first processing circuitry based on determined positional classification and the clustering of each processor core of the plurality of processor cores.

Another example (e.g., example 36) relates to a previous example (e.g., example 35) or to any other example, further comprising that the positional classification within the physical layout of the first processor circuitry comprises a corner position, an edge position, or a central position of the proof the physical layout of the first processor circuitry.

Another example (e.g., example 37) relates to a previous example (e.g., one of the examples 22 to 36) or to any other example, further comprising controlling each processor core of the plurality of processor cores to execute the respective workload for a predetermined time.

Another example (e.g., example 38) relates to a previous example (e.g., one of the examples 22 to 37) or to any other example, further comprising controlling each processor core of the plurality of processor cores to execute the respective workload until a change in temperature of the obtained respective temperature measurement data of the workload executing processor core is below a predetermined threshold.

Another example (e.g., example 39) relates to a previous example (e.g., one of the examples 22 to 38) or to any other example, further comprising that the temperature measurement data being acquired at predetermined time intervals.

Another example (e.g., example 40) relates to a previous example (e.g., one of the examples 22 to 39) or to any other example, further comprising that the physical layout comprises a spatial positioning of the processor cores within the processing circuitry.

An example (e.g., example 41) relates to a method comprising controlling each of a component of computer architecture block to process a respective workload, obtaining temperature measurement data from each component of the computer architecture block, wherein the temperature measurement data is acquired during the processing of the respective workloads by the respective component, and inferring a physical layout of the computer architecture block based on the obtained temperature measurement data from each component of the computer architecture block.

Another example (e.g., example 42) relates to a previous example (e.g., example 41) or to any other example, further comprising that the computer architecture block is at least one of a memory, an uncore, an AI compute unit.

An example (e.g., example 43) relates to an apparatus comprising processing circuitry configured to control each processor core of a plurality of processor cores of a first processing circuitry to execute a respective workload, obtain temperature measurement data from each processor core of the plurality of processor cores, wherein the temperature measurement data is acquired during the executing of the respective workloads by the respective processor core of plurality of processor cores, and infer a physical layout of the first processing circuitry based on the obtained temperature measurement data from each processor core of the plurality of processor cores of the first processing circuitry.

An example (e.g., example 44) relates to a device comprising means for processing for controlling each processor core of a plurality of processor cores of a first processing circuitry to execute a respective workload, obtaining temperature measurement data from each processor core of the plurality of processor cores, wherein the temperature measurement data is acquired during the executing of the respective workloads by the respective processor core of plurality of processor cores, and inferring a physical layout of the first processing circuitry based on the obtained temperature measurement data from each processor core of the plurality of processor cores of the first processing circuitry.

Another example (e.g., example 45) relates to a non-transitory machine-readable storage medium including program code, when executed, to cause a machine to perform any one of the methods of examples 22 to 40 or 41 to 42.

Another example (e.g., example 46) relates to a computer program having a program code for performing any one of the methods of examples 22 to 40 or 41 to 42 when the computer program is executed on a computer, a processor, or a programmable hardware component.

Another example (e.g., example 47) relates to a machine-readable storage including machine readable instructions, when executed, to implement a method or realize an apparatus as claimed in any pending examples.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
control each processor core of a plurality of processor cores of a first processing circuitry to execute a respective workload;
obtain temperature measurement data from each processor core of the plurality of processor cores, wherein the temperature measurement data is acquired during the executing of the respective workloads by the respective processor core of plurality of processor cores; and
infer a physical layout of the first processing circuitry based on the obtained temperature measurement data from each processor core of the plurality of processor cores of the first processing circuitry.

2. The apparatus according to claim 1, wherein the processing circuitry is to execute the machine-readable instructions to distribute a processing load among the plurality of processor cores of the first processor based on the inferred physical layout.

3. The apparatus according to claim 1, wherein the obtained temperature measurement data comprises, for each of the plurality of processor cores, a respective temperature measurement data set corresponding to a respective processor core,
wherein a temperature measurement data set corresponding to a particular processor core comprises temperature measurement data of the plurality of processor cores acquired while the particular processor core is executing the respective workload.

4. The apparatus according to claim 3, wherein the processing circuitry is to execute the machine-readable instructions to
determine numeric values for each processor core of the plurality of processor cores,
wherein for a particular processor core, the numeric values for said particular processor core describe a respective relationship between a temperature pattern of the temperature measurement data of the particular processor core from the temperature measurement data set of said particular processor core and temperature patterns of the respective temperature measurement data of the other processor cores from the temperature measurement data set of said particular processor core.

5. The apparatus according to claim 4, wherein the respective relationship is a linear relationship.

6. The apparatus according to claim 3, wherein the processing circuitry is to execute the machine-readable instructions to perform, for each processor core of the plurality of processor cores, a regression analysis,
wherein for a particular processor core, the regression analysis is performed between the temperature measurement data of the particular processor core from the temperature measurement data set of said particular processor core and the respective temperature measurement data of the other processor cores from the temperature measurement data set of said particular processor core.

7. The apparatus according to claim 3, wherein the processing circuitry is to execute the machine-readable instructions to
perform, for each processor core of the plurality of processor cores, a linear regression analysis, wherein for a particular processor core, the linear regression analysis is performed between the temperature measurement data of the particular processor core from the temperature measurement data set of said particular processor core and the respective temperature measurement data of the other processor cores from the temperature measurement data set of said particular processor core; and
determine, for each processor core of the plurality of processor cores, linear regression coefficients, wherein for a particular processor core, the linear regression coefficients for said particular processor describe a respective linear relationship between the temperature measurement data of said particular processor from the temperature measurement data set of said particular processor core and the respective temperature measurement data of the other processor cores from the temperature measurement data set of said particular processor core.

8. The apparatus according to claim 3, wherein the processing circuitry is to execute the machine-readable instructions to determine, for each processor core of the plurality of processor, a clustering of the plurality of processor cores into a number of clusters,
wherein for a particular processor core, the clustering is based on the temperature measurement data set corresponding to said particular processor core.

9. The apparatus according to claim 4, wherein the processing circuitry is to execute the machine-readable instructions to determine, for each processor core of the plurality of processor, a clustering of the plurality of processor cores into a number of clusters,
wherein for a particular processor core, the clustering is based on the determined numeric values for said particular processor core of the plurality of processor cores.

10. The apparatus according to claim 9, wherein for a particular processor core, each cluster of the plurality of clusters comprises processor cores corresponding to numeric values of the numeric values of said particular processor core within a range.

11. The apparatus according to claim 4, wherein the processing circuitry is to execute the machine-readable instructions to determine the physical layout of the first processing circuitry based on the determined numeric values of each processor core of the plurality of processor cores.

12. The apparatus according to claim 8, wherein the processing circuitry is to execute the machine-readable instructions to determine the physical layout of the first processing circuitry based on the determined clustering of each processor core of the plurality of processor cores.

13. The apparatus according to claim 12, wherein the processing circuitry is to execute the machine-readable instructions to determine the physical layout of the first processing circuitry based on correlating the determined clustering of each processor core of the plurality of processor cores.

14. The apparatus according to claim 8, wherein the processing circuitry is to execute the machine-readable instructions to
determine, for each processor core of the plurality of processor cores, a positional classification within the physical layout of the first processor circuitry, based on at least one of the determined clusterings of the plurality of processor cores; and
determine the physical layout of the first processing circuitry based on determined positional classification and the clustering of each processor core of the plurality of processor cores.

15. The apparatus according to claim 14, wherein the positional classification within the physical layout of the first processor circuitry comprises a corner position, an edge position, or a central position of the physical layout of the first processor circuitry.

16. The apparatus according to claim 1, wherein the processing circuitry is to execute the machine-readable instructions to control each processor core of the plurality of processor cores to execute the respective workload for a predetermined time.

17. The apparatus according to claim 1, wherein the processing circuitry is to execute the machine-readable instructions to control each processor core of the plurality of processor cores to execute the respective workload until a change in temperature of the obtained respective temperature measurement data of the workload executing processor core is below a predetermined threshold.

18. The apparatus according to claim 1, wherein the physical layout comprises a spatial positioning of the processor cores within the first processing circuitry.

19. An apparatus comprising interface circuitry, machine-readable instructions and processing circuitry to execute the machine-readable instructions to:
control each of a component of computer architecture block to process a respective workload;
obtain temperature measurement data from each component of the computer architecture block, wherein the temperature measurement data is acquired during the processing of the respective workloads by the respective component; and
infer a physical layout of the computer architecture block based on the obtained temperature measurement data from each component of the computer architecture block.

20. A method comprising:
controlling each processor core of a plurality of processor cores of a first processing circuitry to execute a respective workload;
obtaining temperature measurement data from each processor core of the plurality of processor cores, wherein the temperature measurement data is acquired during the executing the respective workloads by the respective processor core of plurality of processor cores; and
inferring a physical layout of the first processing circuitry based on the obtained temperature measurement data from each processor core of the plurality of processor cores of the first processing circuitry.
